(19) United States
(12) Patent Application Publication
(10) Pub. No.: US 2006/0083247 A1
(43) Pub. Date: Apr. 20, 2006

(54) Prefix lookup using address-directed hash tables

(75) Inventor: Ashish K. Mehta, Menlo Park, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 10/964,987

(22) Filed: Oct. 14, 2004

(51) Int. Cl. H04L 12/56

(52) U.S. Cl. 370/395.32

(57) ABSTRACT

A method for inserting a prefix, including traversing a trie node block structure to obtain a trie node block in which to insert the prefix, determining whether the trie node block is associated with a hash table, if the trie node block is not associated with a hash table: calculating a set of hash values for a trie node in the trie node block, and populating the hash table using the set of hash values calculated for the trie node, and inserting the prefix in an appropriate location in the hash table using at least one of the set of hash values associated with the trie node.

### BACKGROUND

In Internet communications, electronic packets of data are sent from an originating host to a receiving host by means of the Internet Protocol (IP). IP uses routers to transmit packets from hosts connected to one IP sub-network, or subnet, to hosts connected to different IP sub-networks. When an IP host (the source host) transmits a packet to another IP host (the destination), the source host consults a routing table to determine the IP address of the router that should be used to forward the packet to the destination host.

IP address lookup is a major bottleneck in high performance routers. Address lookup would be simple if each IP destination address could be looked up in a table that lists the output link for every assigned Internet address. In such a case, a hashing algorithm could be used for address lookup, but a router would have to maintain a hash table with millions or even billions of entries. To reduce database size, and the traffic needed to continually update the databases, a router database actually contains a smaller set of address prefixes. This reduces router database size, but at the cost of requiring a more complex lookup scheme called longest matching prefix.

The longest matching prefix address lookup scheme requires the router to determine which of the prefixes in the router database has the longest exact match when compared to the destination address in the packet. For example, a router database may have the address prefixes P1=0101, P2=0101101, and P3=010110101011. If the first 12 bits of the destination address are 010110101101, the longest matching prefix is P2. But, if the first 12 bits of the destination address are 010110101011, the longest matching prefix is P3.

A common method for determining the longest matching prefix for a given destination address uses a per-netmask hash table. More specifically, the per-netmask table is arranged such that a single hash bucket exists for each netmask. For example, a router configured to route 32-bit IP addresses would maintain a hash table which includes 32 hash buckets (i.e., one for each netmask). Using the aforementioned per-netmask hash table, the router may then proceed to find the longest matching prefix.

More specifically, when the router receives a destination address, the router initiates a search for the longest matching address at the bottom of the hash table (e.g., at the portion of the hash table corresponding to a netmask of 32) by calculating a hash value using the destination address and the netmask of 32, for example. The router then uses the hash value to index into a hash bucket within the hash table. The router then searches the hash bucket for a matching prefix. If a matching prefix is found, then the lookup terminates. If the matching prefix is not found in the current hash bucket, then the netmask is decremented (e.g., if the prefix was not found in the hash bucket associated with a netmask of 32, then a new hash value is calculated using a netmask of 31), and the corresponding hash bucket in the hash table is searched for a matching prefix. The aforementioned process is repeated until a matching prefix is encountered.

### SUMMARY

In general, in one aspect, the invention relates to a method for inserting a prefix, comprising traversing a trie node block structure to obtain a trie node block in which to insert the prefix, determining whether the trie node block is associated with a hash table, if the trie node block is not associated with a hash table calculating a set of hash values for a trie node in the trie node block, and populating the hash table using the set of hash values calculated for the trie node, and inserting the prefix in an appropriate location in the hash table using at least one of the set of hash values associated with the trie node.

In general, in one aspect, the invention relates to a method for obtaining a prefix for a destination address, comprising segmenting the destination address in to a plurality of segments, traversing a trie node block structure using the plurality of segments, if a trie node in the trie node block structure is encountered that has a NULL next pointer, then obtaining a first hash value stored in the trie node, querying a first hash table entry in a hash table associated with the trie node in which the trie node is located using the first hash value and a first netmask, and obtaining the prefix if the prefix is located in the first hash table entry.

In general, in one aspect, the invention relates to a router system for looking-up a prefix for a destination address, comprising a processor, a memory, a storage device; and software instructions stored in the memory for enabling the router system under control of the processor, to segment the destination address in to a plurality of segments, traverse a trie node block structure using the plurality of segments, if a trie node in the trie node structure is encountered that has a NULL next pointer, then obtain a first hash value stored in the trie node, query a first hash table entry in a hash table associated with the trie node in which the trie node is located using the first hash value and a first netmask, and obtain the prefix if the prefix is located in the first hash table entry.

In general, in one aspect, the invention relates to a router system for inserting a prefix, comprising a processor, a memory, a storage device, and software instructions stored in the memory for enabling the router under control of the processor, to traverse a trie node block structure to obtain a trie node block in which to insert the prefix, determine whether the trie node block is associated with a hash table, if the trie node block is not associated with a hash table calculate a set of hash values for a trie node in the trie node block, populate the hash table using the set of hash values calculated for the trie node, and insert the prefix in an appropriate location in the hash table using at least one of the set of hash values associated with the trie node.

In general, in one aspect, the invention relates to a router system comprising a trie node block structure comprising at least one trie node block associated with a hash table, wherein the hash table is configured to store a prefix at a location determined by a netmask and a hash value, wherein the at least one trie node block comprises at least one trie node, wherein the at least one trie node comprises the hash value, and a router configured to traverse the trie node block structure to obtain the prefix using the hash table.

In general, in one aspect, the invention relates to a computer readable medium comprising software instructions to insert a prefix, wherein the software instructions comprise functionality to traverse a trie node block structure to obtain a trie node block in which to insert the prefix, determine whether the trie node block is associated with a hash table, if the trie node block is not associated with a hash table calculate a set of hash values for a trie node in the trie node block, and populate the hash table using the set of hash values calculated for the trie node, and insert the prefix in an appropriate location in the hash table using at least one of the set of hash values associated with the trie node.

In general, in one aspect, the invention relates to a computer readable medium comprising software instructions to obtaining a prefix for a destination address, wherein the software instructions comprise functionality to segment the destination address in to a plurality of segments, traverse a trie node block structure using the plurality of segments, if a trie node in the trie node block structure is encountered that has a NULL next pointer, then obtain a first hash value stored in the trie node, query a first hash table entry in a hash table associated with the trie node in which the trie node is located using the first hash value and a first netmask, and obtain the prefix if the prefix is located in the first hash table entry.

Other aspects of the invention will be apparent from the following description and the appended claims.

### BRIEF DESCRIPTION OF DRAWINGS

FIG. 1 shows a flow chart for inserting a prefix into a trie node block in accordance with one embodiment of the invention.

FIG. 2 shows a trie node block structure in accordance with one embodiment of the invention.

FIG. 3 shows a flow chart describing a method of using trie node blocks in accordance with one embodiment of the invention.

### DETAILED DESCRIPTION

Exemplary embodiments of the invention will be described with reference to the accompanying drawings. Like items in the drawings are shown with the same reference numbers. Further, the use of “ST” in the drawings is equivalent to the use of “Step” in the detailed description below.

In one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, one or more embodiments of the invention provide a method and system for performing an IP prefix lookup. More specifically, embodiments of the invention provide a method and system for performing IP prefix lookup using a trie node structure (i.e., one or more connected trie node blocks) and corresponding per-trie node block hash tables. Further, embodiments of the invention provide a method and apparatus for pre-computing hash values required to perform IP prefix lookup, thereby increasing efficiency of IP prefix lookup.

The following discussion details embodiments for inserting a prefix into a particular trie node within a trie node block and for using the resulting trie node blocks to perform look-up of IP prefixes. In one embodiment of the invention, each trie node block corresponds to a table containing one or more trie nodes, where the tables are, for example, located in a router database. Each trie node contains a next pointer, which may be used to point to another trie node or trie node block. The trie node blocks are organized in a hierarchy, where each level corresponds to a particular set of bits within a prefix. For example, assuming that each trie node block corresponds to eight-bits of an IP prefix, then level one corresponds to bits 0-7 in the prefix, level two corresponds to bits 8-15 in the prefix, etc. The bits corresponding to a particular level are used to index into the particular trie node in a particular trie node block at that level. Those skilled in the art will appreciate that the use of eight-bit segments for nodes is merely an example and that other size nodes may be used.

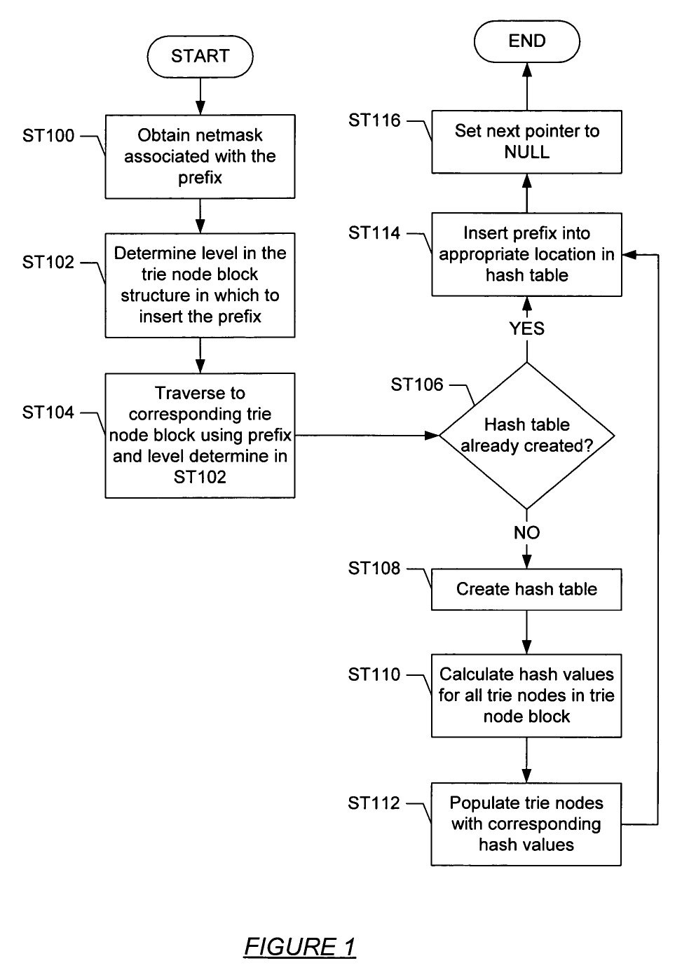

FIG. 1 shows a flow chart for inserting a prefix into a trie node block in accordance with one embodiment of the invention. Initially, a netmask of the prefix that is to be inserted is obtained (Step 100). The netmask corresponds to a bit mask that is applied to a destination address (prior to determining whether match exists between the prefix and the destination address). The netmask is subsequently used to determine the level in the trie block node structure in which to insert the prefix (ST102). For example, if the trie node block structure is organized using eight-bit levels, then the netmask is divided by eight and the quotient plus one corresponds to the level within the trie node block structure. For example, if 129.101.80/15 is the prefix, then the prefix would be inserted into the second level of the trie node block structure. Those skilled in the art will appreciate that the trie node block structure may be segmented into any 2ⁿ-bit size segments (where n is a whole number).

The trie node block structure is subsequently traversed, using the prefix, to the appropriate level (ST104). Continuing with the previous example, once it is determined that prefix 129.101.80/15 is to be inserted into the second level, the first eight bits (i.e., 129) are used to index into the first level of the trie node block structure. The second eight bits (i.e., 101) are then used to index into the second level of the trie node block structure. In this example, because the prefix is to be inserted into the second level, the remaining bits in the prefix are not used to traverse the trie node block structure. Once ST104 is completed, the trie node block (and the trie node) with which the prefix is associated with is identified.

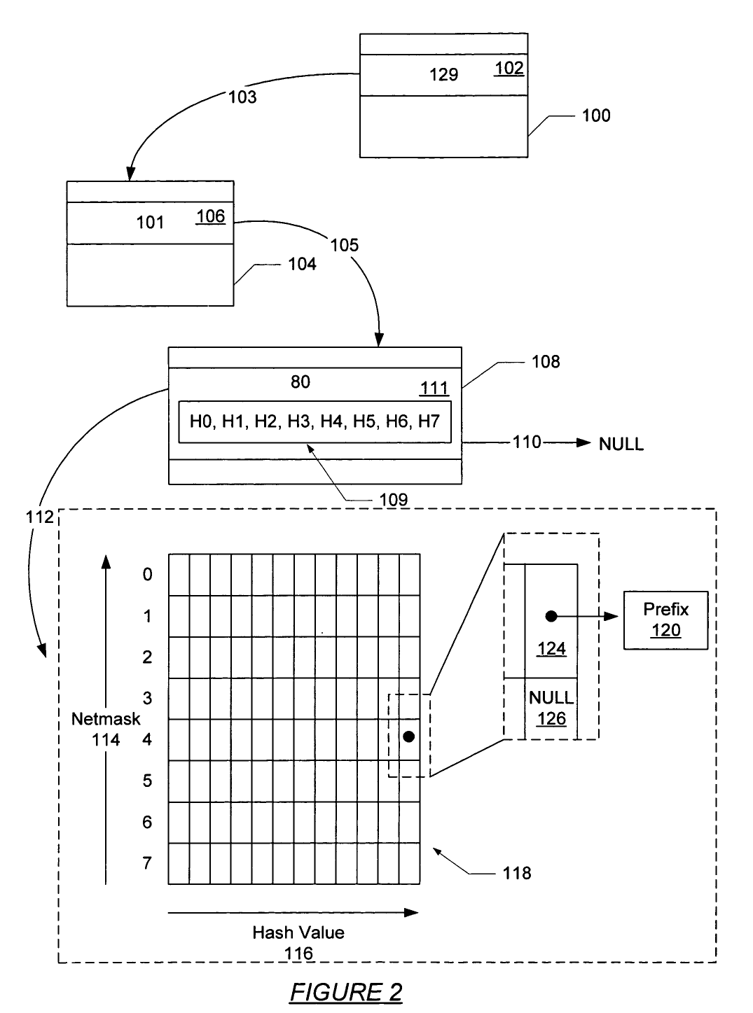

Those skilled in the art will appreciate that the trie node block structure may be traversed using pointers connecting the trie node blocks. Further, those skilled in the art will appreciate that if the appropriate trie node block at the level determined in ST102 does not exist, then the appropriate trie node block is created as part of ST104. Continuing with the discussion of FIG. 1, a determination then is made whether a hash table associated with the trie node block at the level of the trie node block determined in ST102 exists (ST106). If a hash table is not currently associated with the trie node block at the level of the trie node block determined in ST102, then a hash table is created (Step 108). An embodiment of the hash table is shown in FIG. 2 below. Hash values for every trie node in the trie node block are then calculated (ST110).

In one embodiment of the invention, calculating hash values for each trie node in the trie node block corresponds to calculating a series of hash values using an eight-bit segment and a netmask. Thus, for a given trie node block, 256 possible eight-bit segment values (i.e., 0 to 255) and eight possible netmasks exist. The values of the eight possible netmasks depend on the level in which the trie node block with which the prefix is associated with is located. For example, if the trie node block is located in the third level of the trie node block structure, then the netmask correspond to 16 to 23. For a given trie node in the node block, eight hash values are calculated (i.e., hash values calculated using the prefix and each of the eight netmasks). Once the hash values are calculated for a given trie node in the trie node block, the hash values are stored in the trie node within the trie node block (Step 112).

Once the hash values for each trie node in the trie node block are calculated, or if a hash table was previously associated with the trie node block, then the prefix is inserted into the correct location within the hash table (Step 114). In one embodiment of the invention, inserting the prefix into the appropriate location corresponds using a netmask of the prefix and the corresponding hash value to index into the hash table. Once the appropriate location is found in the hash table, the prefix may either be directly inserted into the hash table, or there may be a pointer to the prefix at the appropriate location in the hash table.

Once the prefix has been inserted into the hash table, the next pointer in the trie node (within the trie node block corresponding to the prefix) is set to NULL (Step 116). Those skilled in the art will appreciate that as the trie node block structure becomes populated with prefixes, each trie node block within the trie node block structure will be associated with a hash table. After the aforementioned process is performed, the prefix is inserted into a hash table associated with the trie node.

FIG. 2 shows trie node blocks in accordance with one embodiment of the invention. More specifically, in accordance with one embodiment of the invention, FIG. 2 shows the result of inserting a prefix into a trie node block using the process described in FIG. 1.

In the particular embodiment shown in FIG. 2, prefix 129.101.80/20 is inserted into a trie node structure. Initially, the netmask (i.e., 20) associated with the prefix is obtained. The netmask is then used to determine the level of the trie node structure in which to insert the prefix. Assuming eight-bit segments, the prefix is to be inserted into the third level (i.e., the resulting quotient of 20 divided by 8 plus 1) of the trie node block structure. The prefix is subsequently segmented into three eight-bit segments (i.e., 129, 101, and 80). The first eight-bit segment (i.e., 129) is used to index into trie node block (100) and, more specifically, into trie node (102) within trie node block (100). The second eight-bit set (i.e., 101), is then used to index into trie node block (104), and more specifically, into trie node (106) within trie node block (104). A next pointer (103) in trie node (102) is subsequently set to point to trie node block (104). Finally, the third eight-bit segment (i.e., 80) is used to index into trie node block (108), and more specifically, into trie node (111) within trie node block (108). A next pointer (105) in trie node (106) is subsequently set to point to trie node block (108).

At this stage, there are no additional eight-bit segments in the prefix, thus the next pointer (110) is set to NULL and the prefix is inserted into a hash table (118) associated with the trie node block (108). In this example, assume that no hash table (118) was previously associated with trie node (108). Thus, the hash table (118) is created and a pointer (112) from trie node (111) is set to reference the hash table (118). In the embodiment shown in FIG. 2, the hash table (118) is arranged such that a given entry within the hash table (e.g., 124) may be located using a netmask (114) and a hash value (116).

Prior to inserting the prefix (120) into the hash table (118), the hash values for each trie node within trie node block (108) are calculated and stored in the corresponding trie node. In the example, trie node block (108) contains 256 trie nodes corresponding to prefixes 129.101.0 through 101.129.255. For trie node (111), eight hash values are calculated using the associated prefix (i.e., 129.101.80) and the corresponding eight netmasks (i.e., netmasks 16-23, wherein netmasks 16-23 correspond to 11111111.11111111.00000000.00000000 to 11111111.11111111.11111111.0000000, respectively, for the instant example). As shown in FIG. 2, the resulting hash values (e.g., H0, H1, H2, H3, H4, H5, H6, H7) (109) calculated for trie node (111) are then stored in trie node (111). The resulting hash values for a given trie node may be referred to a prefix hash values. Hash values H0 through H7 correspond to hash values calculated using the prefix and netmask 0 through netmask 7. As noted above, the values of netmask 0 through netmask 7 depends on the level in trie node blocks structure that the corresponding has table is associated with. In the instant example, netmask 0 through netmask 7 corresponds to netmasks of value 16 through netmasks of value 23.

Continuing with the description of FIG. 2, the prefix is subsequently stored in the appropriate location within the hash table (118) using the netmask (i.e., 20) and the corresponding hash value (i.e., H5). In a conventional routing table there are 32 netmasks, (i.e., 0 to 31); however, because the present invention uses hash tables associated with only eight-bit segments, only eight netmasks exist for a given eight-bit segment.

In the embodiment shown in FIG. 2, the location indexed by the netmask and the corresponding hash value is the entry (124). Further, in the embodiment shown in FIG. 2, the prefix (120) is referenced by a pointer located in the location indexed by the netmask and the corresponding hash value. All other locations within the hash table (118) that do not contain/reference a prefix are either empty or contain a NULL pointer (as shown, for example, in the entry (126) in the hash table (118)). Though not shown in FIG. 2, each trie node may have a pointer (i.e., a back pointer) to the parent trie node block from which the trie node originated.

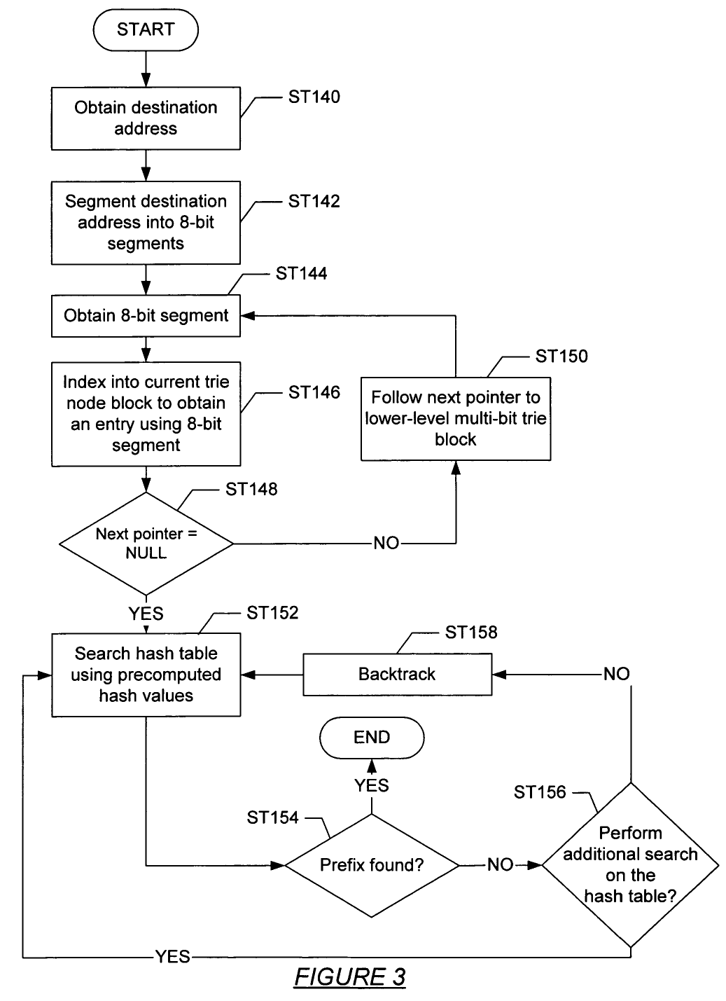

FIG. 3 shows a flow chart describing a method of using trie node blocks in accordance with one embodiment of the invention. Initially, a destination address is obtained (Step 140). In one embodiment of the invention, the destination address is a 128-bit IPv6 address. Alternatively, the destination address is a 32-bit IPv4 address. The destination address is subsequently segmented into eight-bit segments (ST142). The first eight-bit segment is subsequently obtained (Step 144). The eight-bit segment is then used to index into a trie node within the root trie node block (Step 146). If the next pointer in the trie node is not NULL (Step 148), then the next pointer in the trie node is followed to the corresponding trie node block (Step 150). Steps 144-150 are repeated until a trie node having next pointer equal to NULL is encountered (Step 148).

When a trie node having a next pointer equal to NULL is encountered, a hash table is searched using the pre-computed hash values (discussed above) (Step 152). More specifically, a first hash value associated with the trie node (i.e., the trie node reached through the traversal in ST144-ST148) is used with a corresponding netmask to obtain an index into the hash table. In one embodiment of the invention, the fist hash value corresponds to the longest netmask associated with the trie node block. For example, if the traversal of the trie node block structure terminated with a trie node in the third level of the trie node block structure, then a netmask of 23 and hash value H7 (described above) would be used to index into the hash table.

If there is a prefix (or a pointer to the prefix) at the index (Step 154), then the longest matching prefix is found and the process ends. Alternatively, if a prefix is not found, then a determination is made whether to perform an additional search in the current hash table (Step 156). In particular, if additional hash value/netmask combinations exist to lookup in the hash table, then additional searches of the hash table. In one embodiment of the invention, the following is an ordered list of all netmask/hash value pairs used to search for a prefix at a particular level of the trie node block structure: [netmask 7, H7], [netmask 6, H6], [netmask 5, H5], [netmask 4, H4], [netmask 3, H3], [netmask 2, H2], [netmask 1, H1], and [netmask 0, H0]. Note that Steps ST152-ST156 are repeated until either a prefix is found or all locations corresponding to hash value/netmask pairs for the current hash table have been searched.

If the current hash table does not include the prefix, then a process performing the method shown in FIG. 3 backtracks to the previous level in the trie node block structure to the trie node block corresponding the previous eight-bit segment (Step 158). Steps ST152-ST156 are then repeated until either a matching prefix is found or the all levels in the trie node block structure are searched and no matching prefix is found.

Those skilled in the art will appreciate that while the above description discusses inserting a prefix into a particular trie node block, the invention may be extended to deleting a prefix from a trie node. In one embodiment of the invention, each trie node block corresponds to an array indexed by eight-bit segments. In one embodiment of the invention, the representation of the trie node blocks and functionality to insert, delete, and look-up prefixes is included within a single router system. More specifically, in one embodiment of the invention, the router system may include a memory and a disk to store the trie node blocks as well as software that includes functionality to insert, delete, and look-up prefixes within the trie node blocks. Further, the router system may include a processor that is configured to execute the software instructions. In addition, the router system may include one or more network interfaces to connect to the Internet, a local area network, and/or a computer.

Further, the invention may be implemented on a distributed system having a plurality of nodes, where each portion of the invention (e.g., the processor, the trie node block structure, etc.) may be located on a different node within the distributed system. In one embodiment of the invention, the node corresponds to a computer system. Alternatively, the node may correspond to a processor with associated physical memory. Further, software instructions to perform embodiments of the invention may be stored on a computer readable medium such as a compact disc (CD), a diskette, a tape, a file, or any other computer readable storage device. Further, the file and corresponding attribute data structure may be stored on a single disk or across multiple disks (or other storage mediums).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for inserting a prefix, comprising:
traversing a trie node block structure to obtain a trie node block in which to insert the prefix;
determining whether the trie node block is associated with a hash table;
if the trie node block is not associated with a hash table:
calculating a set of hash values for a trie node in the trie node block, and
populating the hash table using the set of hash values calculated for the trie node; and
inserting the prefix in an appropriate location in the hash table using at least one of the set of hash values associated with the trie node.

2. The method of claim 1, furthering comprising:
storing the set of hash values in the trie node.

3. The method of claim 1, wherein calculating the set of hash values for the trie node in the trie node comprises using the prefix and a set of netmasks as inputs to a hash function.

4. The method of claim 1, wherein the set of hash values comprises a prefix hash value, wherein the prefix hash value corresponds to a hash value calculated using the prefix and a set of netmasks.

5. The method of claim 4, wherein the appropriate location corresponds to a hash table entry indexed by the prefix hash value and one netmask in the set of netmasks.

6. The method of claim 1, wherein inserting the prefix comprises setting a pointer from the appropriate location to point to the prefix.

7. The method of claim 1, wherein populating the hash table comprises creating a hash table entry for each hash value-netmask pair.

8. The method of claim 1, wherein the prefix corresponds to an IPv6 prefix.

9. A method for obtaining a prefix for a destination address, comprising:
segmenting the destination address in to a plurality of segments;
traversing a trie node block structure using the plurality of segments;
if a trie node in the trie node block structure is encountered that has a NULL next pointer, then:
obtaining a first hash value stored in the trie node;
querying a first hash table entry in a hash table associated with the trie node in which the trie node is located using the first hash value and a first netmask; and
obtaining the prefix if the prefix is located in the first hash table entry.

10. The method of claim 9, further comprising:
obtaining a second hash value stored in the trie node;
querying a second hash table entry in a hash table using the second hash value and a second netmask, if the prefix is not located in the first hash table entry; and
obtaining the prefix if the prefix is located in the second hash table entry.

11. The method of claim 10, further comprising:
recursively searching the trie node structure for the prefix, if the prefix is not in the first entry or in the second entry.

12. The method of claim 9, wherein the prefix corresponds to an IPv6 prefix.

13. A router system for looking-up a prefix for a destination address, comprising:
a processor;
a memory;
a storage device; and
software instructions stored in the memory for enabling the router system under control of the processor, to:
segment the destination address in to a plurality of segments;
traverse a trie node block structure using the plurality of segments;
if a trie node in the trie node structure is encountered that has a NULL next pointer, then:
obtain a first hash value stored in the trie node;
query a first hash table entry in a hash table associated with the trie node in which the trie node is located using the first hash value and a first netmask; and
obtain the prefix if the prefix is located in the first hash table entry.

14. The router system of claim 13, further comprising software instructions to:
obtain a second hash value stored in the trie node;
query a second hash table entry in a hash table using the second hash value and a second netmask, if the prefix is not located in the first hash table entry;
obtain the prefix if the prefix is located in the second hash table entry.

15. The router system of claim 14, further comprising software instructions to:
recursively search the trie node structure for the prefix, if the prefix is not in the first entry or in the second entry.

16. The router system of claim 13, wherein the prefix corresponds to an IPv6 prefix.

17. A router system for inserting a prefix, comprising:
a processor;
a memory;
a storage device; and
software instructions stored in the memory for enabling the router under control of the processor, to:
traverse a trie node block structure to obtain a trie node block in which to insert the prefix;
determine whether the trie node block is associated with a hash table;
if the trie node block is not associated with a hash table:
calculate a set of hash values for a trie node in the trie node block,
populate the hash table using the set of hash values calculated for the trie node; and
insert the prefix in an appropriate location in the hash table using at least one of the set of hash values associated with the trie node.

18. The router system of claim 17, wherein software instructions to calculate the set of hash values for the trie node in the trie node comprise software instructions to use the prefix and a set of netmasks as inputs to a hash function.

19. The router system of claim 17, wherein the set of hash values comprises a prefix hash value, wherein the prefix hash value corresponds to a hash value calculated using the prefix and a set of netmasks.

20. The router system of claim 19, wherein the appropriate location corresponds to a hash table entry indexed by the prefix hash value and one netmask in the set of netmask.

21. A router system comprising:
a trie node block structure comprising at least one trie node block associated with a hash table,
wherein the hash table is configured to store a prefix at a location determined by a netmask and a hash value,
wherein the at least one trie node block comprises at least one trie node,
wherein the at least one trie node comprises the hash value; and
a router configured to traverse the trie node block structure to obtain the prefix using the hash table.

22. The router system of claim 21, wherein the router system is executing on a plurality of nodes.

23. The router system of claim 22, wherein the router is executing on at least one of the plurality of nodes and the trie node block structure is stored on at least one of the plurality of nodes.

24. A computer readable medium comprising software instructions to insert a prefix, wherein the software instructions comprise functionality to:
traverse a trie node block structure to obtain a trie node block in which to insert the prefix;
determine whether the trie node block is associated with a hash table;
if the trie node block is not associated with a hash table:
calculate a set of hash values for a trie node in the trie node block, and
populate the hash table using the set of hash values calculated for the trie node; and
insert the prefix in an appropriate location in the hash table using at least one of the set of hash values associated with the trie node.

25. A computer readable medium comprising software instructions to obtaining a prefix for a destination address, wherein the software instructions comprise functionality to:
segment the destination address in to a plurality of segments;
traverse a trie node block structure using the plurality of segments;
if a trie node in the trie node block structure is encountered that has a NULL next pointer, then:
obtain a first hash value stored in the trie node;
query a first hash table entry in a hash table associated with the trie node in which the trie node is located using the first hash value and a first netmask; and
obtain the prefix if the prefix is located in the first hash table entry.
